(19) United States
(12) Patent Application Publication
(10) Pub. No.: US 2005/0063016 A1
(43) Pub. Date: Mar. 24, 2005

(54) Printing control method, printing control apparatus and printing control program product

(76) Inventors: Tomoaki Takahashi, Nagano (JP); Tadao Tomiyama, Nagano (JP)

Correspondence Address: MARTINE PENILLA & GENCARELLA, LLP, 710 LAKEWAY DRIVE, SUITE 200, SUNNYVALE, CA, 94085, US

(21) Appl. No.: 10/898,155

(22) Filed: Jul. 22, 2004

(30) Foreign Application Priority Data
Jul. 23, 2003 (JP) 2003-200726

(51) Int. Cl. H04N 1/56; H04N 1/60

(52) U.S. Cl. 358/3.24; 358/523; 358/525

(57) ABSTRACT

During printing upon color conversion of image data color space from a first color space to a second color space with reference to profiles stipulating the correspondence between the first and second color spaces, said image data is input, the environmental temperature of the printer environment is measured, at least two profiles are prepared in advance for realizing certain coloring characteristics on printing media under different temperature conditions, a profile is retrieved according to the temperature conditions corresponding to the measured environmental temperature, and the profile is referenced to produce printing data as the image data undergoes color conversion.

### BACKGROUND OF THE INVENTION

1. Field of the Invention

The present invention relates to a printing control method, printing control apparatus, and printing control program product, and in particular to a printing control method, printing control apparatus, and printing control program product which are capable of suitably switching profiles based on the correspondence between first and second color spaces when printing data is produced during the color conversion of certain first color space image data to a different second color space.

2. Description of the Related Art

Color correction is pre-arranged so as to counteract color deviation which results from changes in the amount of ink that is used whenever the amount of colored ink changes due to temperature. Such color correction is intended to counteract such deviations when the coloring characteristics of color printers at a measured environmental temperature deviate from standard coloring properties at a given standard temperature (such as 25° C.) (see Japanese Unexamined Patent Application (Kokai) 10-278315, for example).

A problem in the conventional apparatuss described above is that such deviation is not always accurately counteracted because the environmental temperature-based correction is carried out with reference to a predetermined standard color conversion table (profile) for exhibiting appropriate coloring characteristics at a single standard temperature.

### SUMMARY OF THE INVENTION

In view of the foregoing, an object of the invention is to provide a printing control method, printing control apparatus, and printing control program product which have a plurality of predetermined standard profiles allowing appropriate coloring characteristics to be exhibited at a plurality of standard temperatures, so that color conversion suited to the environmental temperature can be undertaken by appropriately switching profiles based on the environmental temperature.

To achieve the above object in printing upon color conversion of image data color space from a first color space to a second color space with reference to profiles stipulating the correspondence between the first and second color spaces, the gist of the present invention is to implement the steps of inputting the image data; measuring the environmental temperature in the printer environment; and preparing at least two profiles to realize certain coloring characteristics on printing media under different temperature conditions, retrieving a profile according to the temperature conditions corresponding to the measured environmental temperature, and producing printing data as the image data undergoes color correction with reference to that profile.

Profiles stipulating the correspondence between a first and second color space are used during the color conversion of certain first color space image data to a different second color space. That is, printing data stipulated for a second color space is produced through the color conversion of image data stipulated for a first color space to a second color space based on predetermined profiles. At such times, color conversion adapted to the temperature environment can be realized in the present invention by switching profiles according to the temperature of the environment in which the printer is located (the environmental temperature of the printer environment). To implement such a function, at least two profiles stipulating the correspondence between the first and second colors spaces allowing certain coloring characteristics to be realized on printing media under different temperature conditions are prepared in advance and stored on a recording medium. The ink coloring characteristics on printing media depend on the amount of ink that is ejected, and the amount of ink that is ejected depends on the viscosity of the ink, which varies depending on the environmental temperature. The properties are such that the ink viscosity is lower at higher environmental temperatures, and is higher at lower environmental temperatures. Decreases in the ink viscosity result in a relative increase in the amount of ink that is ejected, and increases in the ink viscosity result in a corresponding decrease in the amount of ink that is ejected. The amount of ink that is ejected can be adjusted according to the extent of the conversion during the color conversion to the second color space using the profile.

Certain coloring characteristics can be achieved at the environmental temperature by taking into consideration the ink viscosity properties during color conversion during the conversion of the first color space image data to the second color space. The present invention thus provides profiles stipulating the correspondence between color spaces according to temperature conditions in order to control the amount of ink that is ejected, so as to realize similar coloring characteristics on printing media even under different temperature conditions as noted above. In this structure, when the image data that is to undergo color conversion is input in the image data input step, the environmental temperature in the printer environment is measured in the environmental measuring step. In the printing data producing step, a profile is retrieved according to the temperature conditions corresponding to the environmental temperature measured in the environmental temperature measuring step, and the profile used for color conversion is switched to the retrieved profile. Thus, in the printing data producing step, the switched profile is referenced to produce the printing data as the image data undergoes color conversion. Certain coloring characteristics can thus be achieved on printing media at the environmental temperature by storing the profiles permitting the predetermined color conversion to be realized according to the temperature conditions, and by switching to the appropriate profile for use during color conversion according to the environmental temperature of the printer.

An example of a procedure for retrieving profiles according to the environmental temperature is to retrieve the profile stipulated for the temperature conditions closest to the measured environmental temperature in the printing data producing step. Thus, in the printing data producing step, the profile referenced during the color conversion of the image data input in the image data input step is switched to the retrieved profile. This enables color conversion based on a stipulated profile permitting certain color conversion under temperature conditions closest to the measured environmental temperature. The profile can thus be switched by a simple method.

As noted above, the profile may be switched to the profile stipulated for the temperature conditions closest to the environmental temperature, or a profile suited to the environmental temperature may be prepared from the stored profiles. When the measured environmental temperature is between the aforementioned different temperature conditions, a profile for the measured environmental temperature may be retrieved by interpolation in the printing data producing step. That is, the profiles at the different temperature conditions are referenced, the correspondence between the first and second color spaces at the measured environmental temperature is extracted by interpolation, and a profile is retrieved based on the extracted correspondence. Thus, in the printing data producing step, the retrieved profile is referenced during the color conversion of the image data input in the image data input step. It is thus possible to retrieve a new profile suited to the measured environmental temperature based on the two profiles, thereby enabling color conversion suited to the environmental temperature.

The above procedures allow a new profile to be prepared when the environmental temperature is between two different temperature conditions. It is also possible that the measured environmental temperature will be outside the temperature conditions. It would be desirable in such cases if a new profile suited to the environmental temperature could be produced from the existing profiles. Thus, in the printing data producing step, when the measured environmental temperature is not between the different temperature conditions, a profile for the measured environmental temperature is retrieved by extrapolation in the printing data producing step. That is, the profiles for the two temperature conditions close to the measured environmental temperature are referenced, the correspondence between the first and second color spaces at the measured environmental temperature is extracted by extrapolation, and a profile is retrieved based on the extracted correspondence. Thus, in the printing data producing step, the retrieved profile is referenced during the color conversion of the image data input in the image data input step. It is thus possible to retrieve a new profile suited to the measured environmental temperature based on the two profiles, thereby enabling color conversion suited to the environmental temperature.

Profiles can be provided for each temperature condition as noted above to realize certain coloring characteristics on printing media at the environmental temperature. The grade of the printing medium affects the coloring characteristics on printing media. The ability to provide a profile for temperature conditions by printing medium grade would produce even more desirable coloring characteristics. A step for selecting the printing medium grade is provided in such instances for selecting the grade of the printing medium on which is printed the printing data produced in the printing data producing step. Profiles for different temperature conditions are prepared in advance for each grade of printing medium and are stored on a recording medium. A profile is retrieved in the printing data producing step on the basis of the temperature conditions corresponding to the environmental temperature measured in the environmental temperature measuring step and the grade of the printing medium selected in the printing medium grade selection step, and the profile referenced during the color conversion of the image data in the printing data producing step is switched to the retrieved profile.

A method for switching profiles according to the environmental temperature is employed in the inventions above, but the environmental humidity in the printer environment also affects the coloring characteristics on printing media when printed by printers. At such times, it would be desirable to be able to implement color conversion capable of realizing certain coloring characteristics at a certain environmental humidity by providing profiles suited to the environmental humidity. Profiles are thus prepared for differing temperature and humidity conditions and recorded on a recording medium. A step for measuring the environmental humidity in the printer environment is implemented, a corresponding profile is retrieved based on the temperature conditions corresponding to the measured environmental temperature and the measured humidity, and the profile referenced during the color conversion of the image data in the printing data producing step is switched to the retrieved profile.

It need hardly be mentioned that the above printing method may be worked in the form of a printing control apparatus for executing the method, and that the invention may be worked in the form of a printing control program product which allows the same functions as a printing control apparatus to be executed by a computer. Recording media for such program products include floppy disks, CD-ROM, opticomagnetic disks, IC cards, ROM cartridges, punch cards, barcodes and other printed matter on which symbols have been printed, internal memory apparatuss for computers (memory such as RAM or ROM), external memory apparatuss, and various other types of computer-readable media.

### BRIEF DESCRIPTION OF THE DRAWINGS

FIG. 1 is a block diagram illustrating the structure of a printing apparatus.

FIG. 2 is a block diagram illustrating the structure of software.

FIG. 3 is a structural diagram illustrating the structure of a printer.

FIG. 4 illustrates an array of ink jet nozzles.

FIG. 5 is a structural diagram illustrating the internal structure of a control circuit.

FIG. 6 illustrates the schematic structure of the interior of a printing head.

FIG. 7 is a schematic diagram illustrating how ink is ejected by the contraction of piezo elements.

FIG. 8 schematically illustrates the relationship between drive waveform and ejected ink.

FIG. 9 is a graph of the relationship between ink weight and dot diameter.

FIG. 10 is a structural diagram illustrating the structure of a color conversion table.

FIG. 11 is a structural diagram illustrating the structure of a profile.

FIG. 12 is a structural diagram illustrating the structure of printer hardware.

FIG. 13 is a structural diagram illustrating the structure of a profile.

FIG. 14 is a structural diagram illustrating the structure of a printer.

FIG. 15 is a structural diagram illustrating the structure of a profile.

### DETAILED DESCRIPTION

Embodiments of the invention are described below in the following order.

1) Printing Apparatus Structure

2) Schematic Structure of Printer

3) Ink Ejection Mechanism

4) Overview of Dot Formation

5) On The Invention

6) Variants

7) Conclusion

1) Printing Apparatus Structure

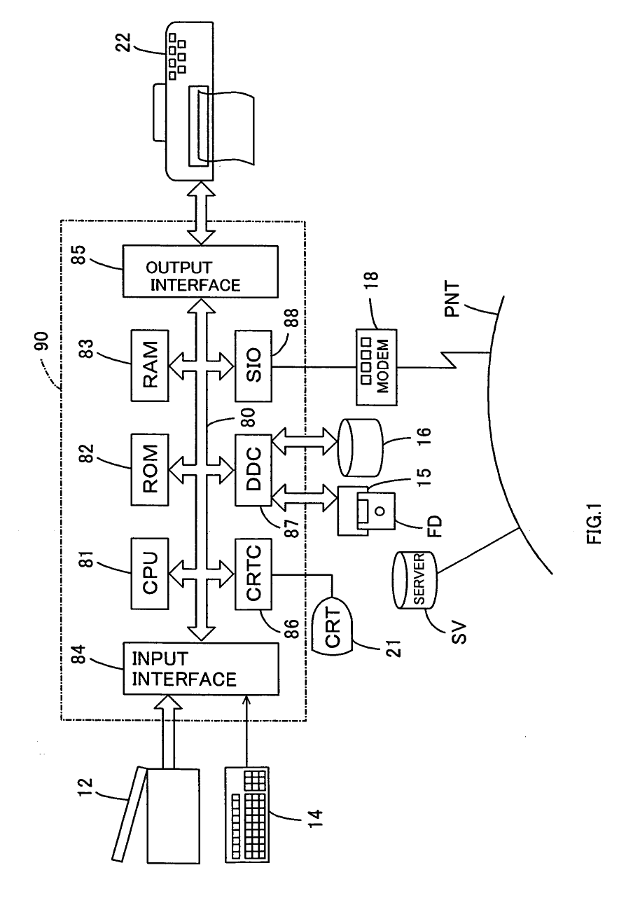

FIG. 1 is a block diagram illustrating the structure of a printing apparatus as an embodiment of an ink ejection control apparatus in the invention.

In the figure, the printing system comprises a scanner 12 and color printer 22 connected to a computer 90, the entirety of which functions as a printing apparatus through the loading and execution of a certain program on the computer 90. As illustrated, the computer 90 comprises the following components connected to each other by a bus 80 based on a CPU 81 for running various computer processes to control operations relating to image processing according to a program. Programs or data needed to run the various computing processes by the CPU 81 are stored in ROM 82. RAM 83 is memory to which various programs needed to run the various computer processes by the CPU 81 are temporarily written.

The input interface 84 controls the input of signals from the keyboard 14 or scanner 12, and the output interface 85 controls the output of data to the printer 22. The CRTC 86 controls the signal output to a color-displayable CRT 21, and the disc controller (DDC) 87 controls the transmission and reception of data between the hard disk 16, floppy drive 15, CD-ROM drive (not shown), or the like. Various programs and the like provided in the form of apparatus drivers or various programs loaded and run in RAM 83 are stored on the hard disk 16.

In addition, a serial input/output interface (SIO) 88 is connected to the bus 80. The SIO 88 is connected to a modem 18, and is connected by means of the modem 18 to a public telephone network PNT. The computer 90 is connected by the SIO 88 and modem 18 to an external network, and connects to a specific server SV in order to allow programs needed for image processing to be downloaded to the hard disk 16. The necessary programs can also be loaded onto floppy disks or a CD-ROM and run by a computer 90.

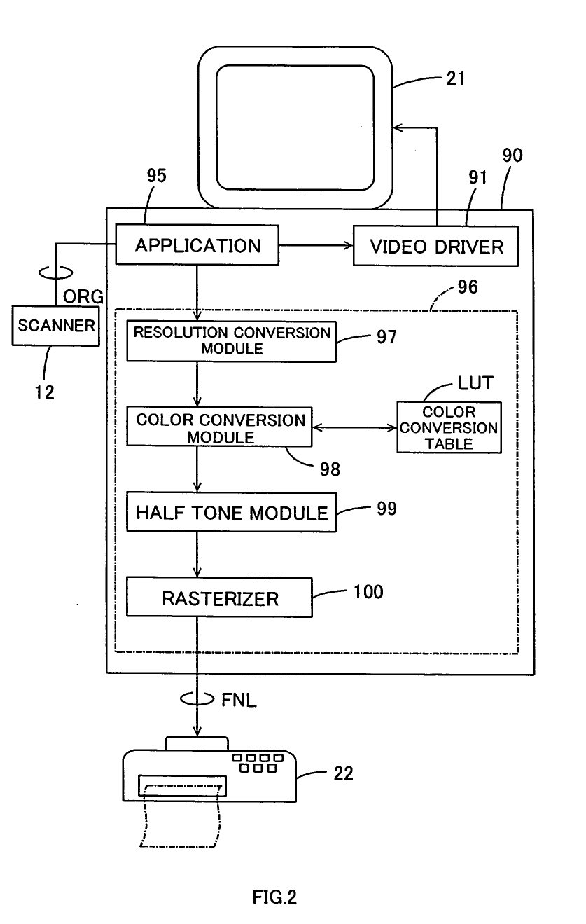

FIG. 2 is a block diagram illustrating the structure of the printing apparatus software.

In the figure, an application program 95 is operated by the computer 90 under the control of a certain operating system. A video driver 91 or printer driver 96 is incorporated in the operating system. Interim image data for transmission to the printer 222 is output from the application program 95 through these drivers. The application program 95 for retouching images or the like reads images from the scanner 12, and displays images on the CRT display 21 through the video driver 91 as the images undergo a certain process. Data ORG supplied from the scanner 12 is source color image data ORG read from a color manuscript and comprising the three color components of red \hat{R}, green (G), and blue (B).

When the application program 95 issues a printing command, the printer driver 96 of the computer 90 receives image data from the application program 95 and converts it to signals which can be processed by the printer 22 (signals given multiple values for each of the colors of cyan, magenta, yellow, and black). In the example illustrated in FIG. 2, the interior of the printer driver 96 comprises a resolution conversion module 97, color conversion module 98, color conversion table LUT, half tone module 99, and rasterizer 100.

The role of the resolution conversion module 97 is to convert the resolution, that is, the number of pixels per unit length, of the color image data handled by the application program 95 to a resolution that can be handled by the printer driver 96. Because the image data which has thus undergone resolution conversion is still image data comprising the three colors RGB, the color conversion module 98 converts it to data of the colors cyan (C), magenta (M), yellow (Y), and black (K) for each pixel while referencing the color conversion table LUT. The gray scale level of the color converted data is 256, for example. The half tone module 99 performs a half tone process to represent the gray scale level on the printer 22 through the dispersal and formation of dots.

In this embodiment, there are three values because the printer 22 can represent three levels per pixel: no dots, small dots, and large dots. The processed image data is arranged by the rasterizer 100 into the order in which the data is to be sent to the printer 22, and is output in the form of the final image data FNL. In this embodiment, the only role of the printer 22 is to form the dots according to the image data FNL, not image processing. The printer driver 96 on the computer 90 side does not adjust drive signals for piezo elements formed into pulse shapes described below in the interior of the printer 22, but the two-way communications function with the printer 22 can be used to make such adjustments on the printer driver 96 side.

2) Schematic Structure of Printer

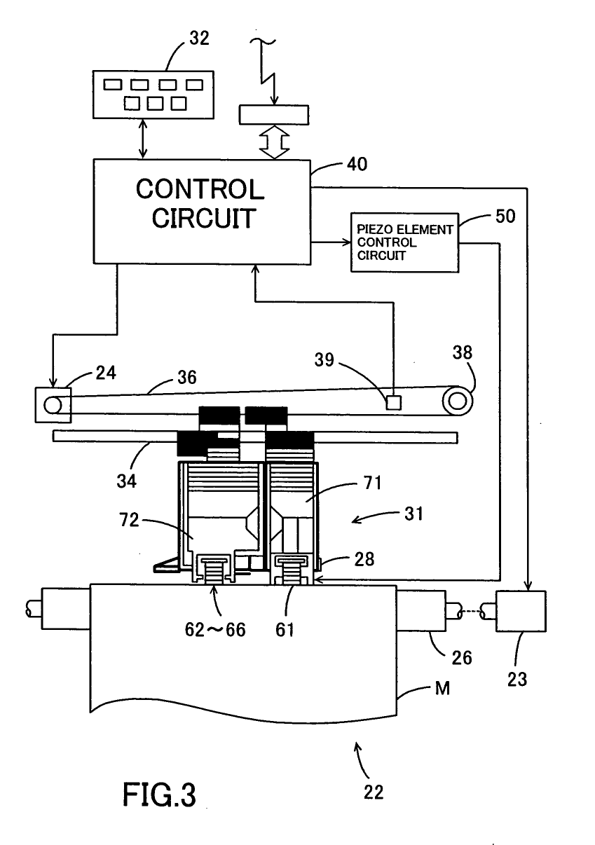

The structure of the printer 22 is described below. FIG. 3 is a structural diagram illustrating the structure of the printer 22. In the figure, the printer 22 is composed of: a mechanism for conveying a printing medium M by means of a paper feed motor 23; a mechanism for the reciprocation of a carriage 31 in the axial direction of a platen 26 by means of a carriage motor 24; a mechanism for driving a printing head 28 mounted on the carriage 31 to eject ink and form dots; a control circuit 40 for handling signals with the paper feed motor 23, carriage motor 24, printing head 28, and operating panel 32; and a piezo element drive circuit 50 for producing drive signals to drive the piezo elements upon receiving signals from the control circuit 40.

The mechanism for the reciprocation of the carriage 31 in the axial direction of the platen 26 is composed of: a sliding shaft 34 suspended parallel to the axis of the platen 26 for slidably holding the carriage 31; a pulley 38 for setting up an endless drive belt 36 with the carriage motor 24; a position sensor 39 for sensing the starting point of the carriage 31; and so forth. Color ink cartridges 72 for housing the four colors of ink of cyan (C), magenta (M), yellow (Y), and a cartridge 71 for black ink (K) are mountable on the carriage 31. Chromatic colored inks may also include light cyan and light magenta, and achromatic ink may include light black.

Two shades of ink are provided for the two colors of cyan and magenta. A total of six ink ejecting heads 61 through 66 are formed in the printing head 28 at the bottom of the carriage 31, and guide tubes 67 for guiding ink from the ink tanks to the heads for the various colors are located in the floor of the carriage 31. When the black (K) ink cartridge 71 and colored ink cartridges 72 are mounted from above on the carriage 31, the guiding tubes 67 are inserted into connecting holes provided in the cartridges, allowing ink to be supplied from the ink cartridges to the ejecting heads 61 through 66.

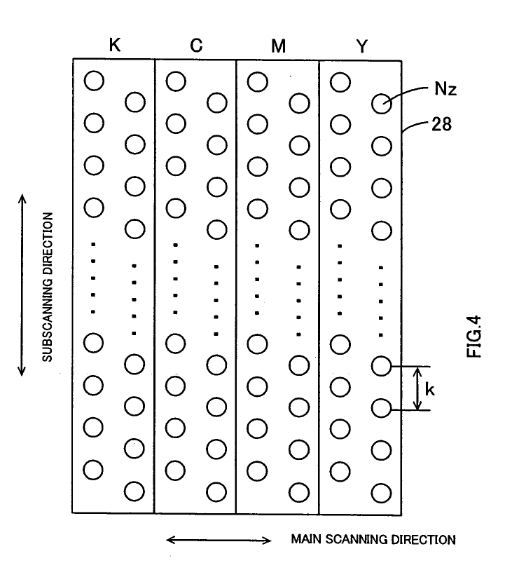

FIG. 4 illustrates the array of ink jet nozzles Nz in ink ejection heads 61 through 66. In the figure, the arrange of nozzles Nz is formed of five nozzle arrays for ejecting ink of each color, where 48 nozzles Nz are arranged in a zigzag pattern at a constant nozzle pitch k. The subscanning direction positions of each nozzle array are aligned with each other. The 48 nozzles Nz included in the nozzle array do not have to be arranged in a zigzag pattern, and may be arranged on a straight line. However, the zigzag pattern illustrated in FIG. 4 has the structural advantage of allowing the nozzles to be easily arranged at a narrower nozzle pitch k.

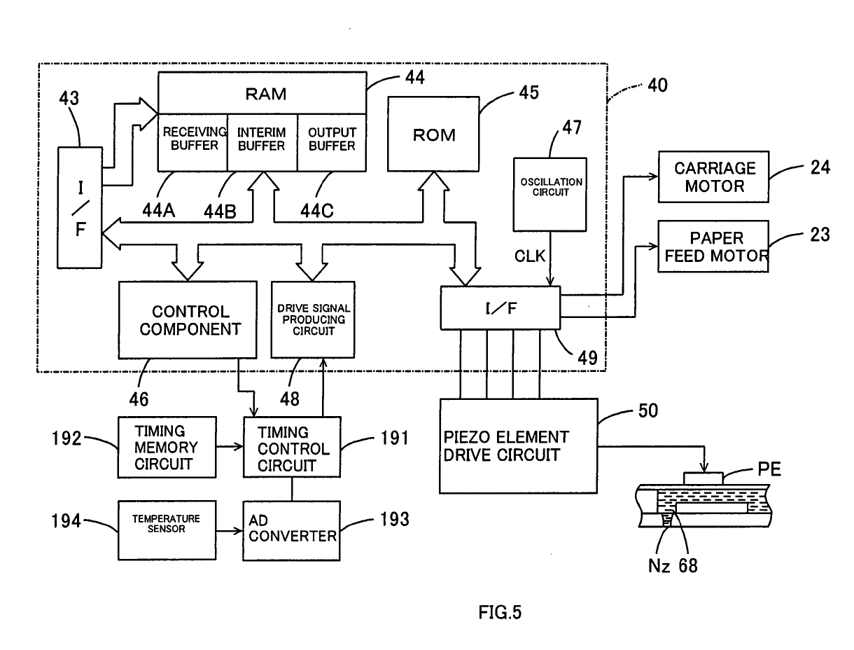

The ejection of ink from the above nozzles Nz is controlled by the control circuit 40 and piezo element drive circuit 50. FIG. 5 illustrates the internal structure of the control circuit 40. In the figure, the interior of the control circuit 40 comprises: an interface 43 (referred to below as I/F) for receiving image data and the like including multiple value gray scale data from the computer 90; RAM 44 for storing various types of data; ROM for storing routines and the like for various types of data processing; a control component 46 consisting of a CPU and the like; oscillation circuit 47; drive signal producing circuit 48 for producing drive signals for the various piezo elements of the printing head 28 described below; and an I/F 49 for transmitting drive signals and printing data developed into dot pattern data to the paper feed motor 23, carriage motor 24, and piezo element drive circuit 50.

Because the printing data is sent from the computer 90 after the triple-value process by the printer driver 96, the control circuit 40 may store the printing data in a receiving buffer 44A, then first develop the data in an output buffer 44C according to the arrangement of the nozzle array in the printer head, and output it by means of the I/F 49. On the other hand, when data sent from the computer 90 is printing data including multiple value gray scale data (such as post-script formation data), the printer 22 should perform the triple-value processing and the like in the control circuit 40. In such cases, the printing data is stored in the receiving buffer 44A in the recording apparatus by means of the I/F 43. It is sent to the interim buffer 44B after command analysis of the recording data stored in the receiving buffer 44A. The recording data is held, in interim form converted to interim code by the control component 46, in the interim buffer 44B, and the control component 46 executes processes for the addition of character print position, type of modification, size, font address, and the like. The control component 46 then analyzes the recording data in the interim buffer 44B, produces three values according to the gray scale data, develops the dot pattern data for the output buffer 44C, and stores it in memory.

In either case, dot patterns with three values are developed and stored in the output buffer 44C. Because the printing head 28 has 48 nozzles for each color, as described below, dot pattern data corresponding to one scan component of a head is prepared for the output buffer 44C, and the dot pattern data is then output by means of the I/F 49. The printing data developed in the form of dot pattern data is composed of 2 bits, for example, in the form of gray scale data for each nozzle, as described below, where 00 corresponds to no dots, 10 corresponds to small dot formation, and 11 corresponds to large dot formation.

3) Ink Ejection Mechanism

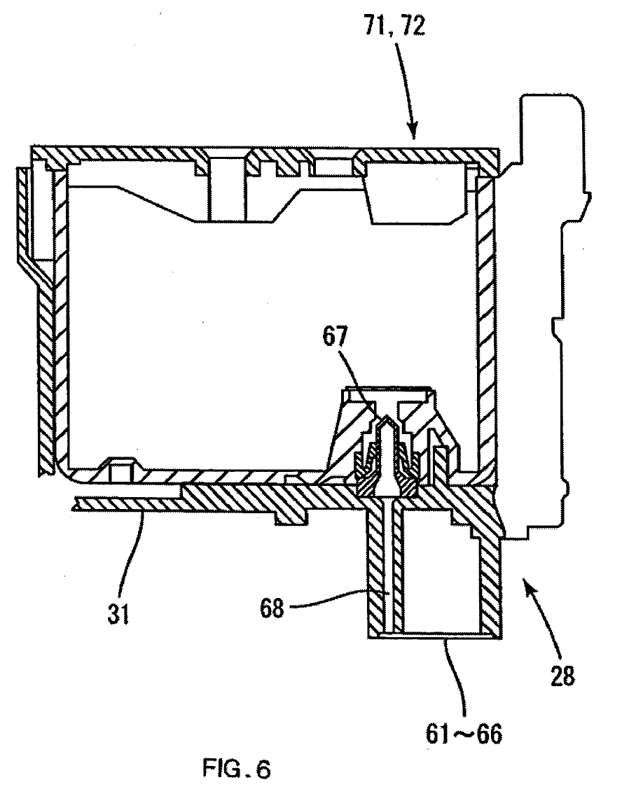

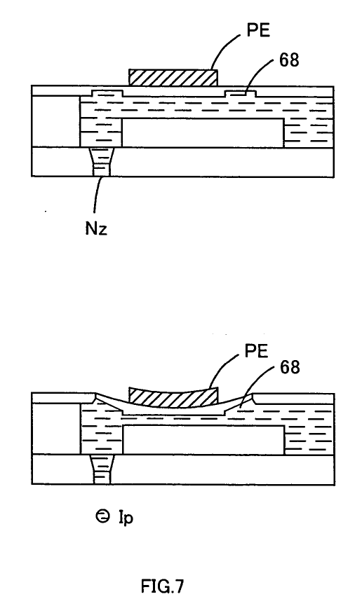

The mechanism for ink ejection and dot formation is described below. FIG. 6 illustrates the schematic structure of the interior of the printing head 28, and FIG. 7 is a schematic diagram illustrating how ink is ejected by the contraction of piezo elements. When the ink cartridges 71 and 72 are mounted on the carriage 31, the capillary tube phenomenon is exploited, as illustrated in FIG. 6, causing the ink in the ink cartridges to be taken up through the guiding tubes 67 and guided to the heads 61 through 66 in the printing head 28 located at the bottom of the carriage 31. When the ink cartridges are first mounted, a special pump causes the ink to be taken up into the heads 61 through 66 for the various colors, but the structure of the suction pump, cap for covering the printing head 28 during such suction, and the like are neither described nor illustrated in the present embodiment.

As noted above, 48 nozzles Nz are provided for each color in the heads 61 through 66 for the various colors. Piezo elements Pe, which are a type of electrostriction element with excellent response, are arranged as pressure generation elements for each nozzle. As illustrated in the upper part of FIG. 7, the piezo element PE is located near the ink channel 68 for guiding the ink to the nozzle Nz. As is well known, the piezo element PE is an element in which the crystal structure undergoes strain upon the application of voltage based on drive signals, resulting in extremely rapid electrical-mechanical energy conversion. In this embodiment, voltage is applied for a certain period of time across the electrodes provided at both ends of the piezo element, thereby causing the piezo element PE to contract while the voltage is applied, deforming the wall on one side of the ink channel 68, as illustrated in the bottom part of FIG. 7. As a result, the volume of the ink channel 68 contracts according to the contraction of the piezo element PE. In response to this contraction, the corresponding amount of ink, particle Ip, is rapidly ejected from the tip of the nozzle Nz. Printing is performed by the ink particle Ip staining the printing medium M mounted on the platen 26.

4) Overview of Dot Formation

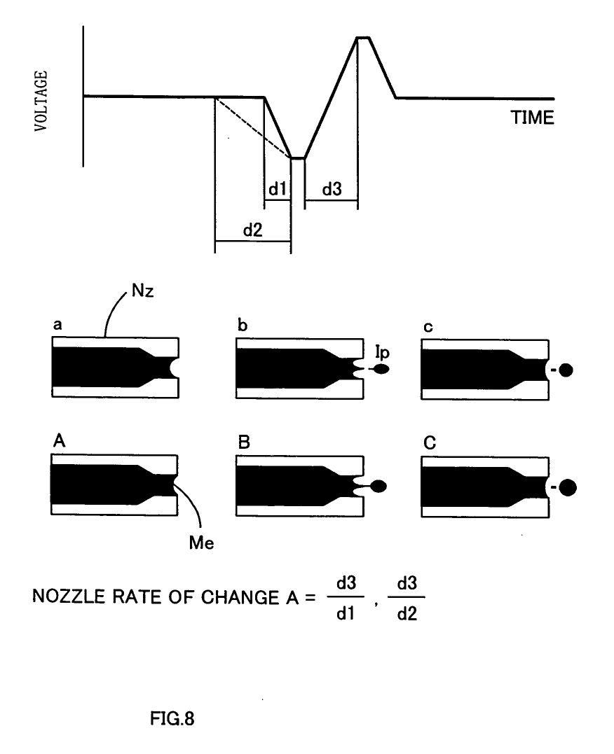

The 48 nozzles Nz for each color in the printer 22 of this embodiment have equivalently formed inside diameters. This type of nozzle Nz can be used to form two kinds of dots with different diameters. This principle is described below. FIG. 8 schematically illustrates the relationship between the ejected ink Ip and the drive waveform of the nozzle Nz during the ejection of the ink. In the figure, the drive waveform represented by the dashed line is the waveform during the ejection of an ordinary dot. When negative voltage is applied to the piezo element PE at section d2, the piezo element PE is deformed in the direction in which the volume of the voltage-producing chamber 132 expands, resulting in the formation of a meniscus Me that is concave toward the inside of the nozzle Nz, as illustrated by A in FIG. 8. On the other hand, the rapid application of negative voltage as illustrated in section d1 using the drive waveform represented by the solid line in FIG. 8 results in a meniscus, as illustrated by a, that is more concave toward the inside than A.

The shape of the meniscus is different depending on the pulse waveform of the negative voltage applied to the piezo element PE for the following reasons. The piezo element deforms in response to the pulse shape of the applied voltage, increasing or decreasing the volume of the voltage generating chamber 132. When the volume of the voltage generating chamber 132 increases, if the deformation is extremely slow, ink is supplied from the shared ink chamber 141 as the volume of the voltage producing chamber 132 increases, with virtually no change in the meniscus. When, on the other hand, the contraction of the piezo element PE is more rapid, and the change in the volume of the voltage generating chamber 132 is more rapid, less ink is supplied from the ink chamber 141 because it is limited by the ink supply port 137, making the meniscus more susceptible to the change in the volume of the voltage producing chamber 132. This balance in the supply of the ink causes the meniscus to not pull back as much when the change in the voltage applied to the piezo element PE is more moderate (see dashed line in FIG. 8), and causes the meniscus to pull back more when the change in applied voltage is more rapid (see the solid line in FIG. 8).

From the retracted state of the meniscus, when positive voltage is then applied to the piezo element PE (section d3), the ink is ejected based on the principles illustrated earlier in FIG. 7. A larger ink drop is ejected as illustrated in B and C from a meniscus that is not very inwardly concave (A), whereas a smaller ink drop is ejected as illustrated by b and c from a meniscus that is more inwardly concave (a). the dot diameter can be changes according to the rate of change (sections d1 and d2) when negative drive voltage is applied, as illustrated above. In this embodiment, section d3/section d1 and section d3/secion d2 are stipulated as pulse rate of change A. This pulse rate of change A is suitably variable in consideration of the coloring characteristics. A certain pulse rate of change A is thus specified during the ejection of ink drops, and voltage based on the specified pulse rate of change A is applied to the piezo element to eject certain ink drops.

As illustrated in FIG. 5 above, the printer 22 comprise a timing memory circuit 192, timing control circuit 191, temperature sensor 194, and AD converter 193 in addition to the control circuit 40 and piezo element drive circuit 50. The temperature sensor 194 senses the temperature of the printing medium M on to which the ink drops are ejected as the environmental temperature of the printer. The medium temperature measured by the temperature sensor 194 is taken through the AD converter 193 into the timing control circuit 191, and can be retrieved by the control circuit 46. The medium temperature retrieved by the control circuit 46 can be communicated to the computer 90 by means of a request from the computer 90 through the I/F 43. The timing control circuit 191 reads the standard pulse rate of change A stored in the timing memory circuit 192, and sends it to the drive signal producing circuit 48 of the control circuit 40. The drive signal producing circuit 48 retrieves the standard pulse change of rate A to determine the pulse shape of the piezo element PE drive signal, and adjusts the timing of the signal outputting this data to the piezo element drive circuit 50 through the I/F 49.

5) On The Invention

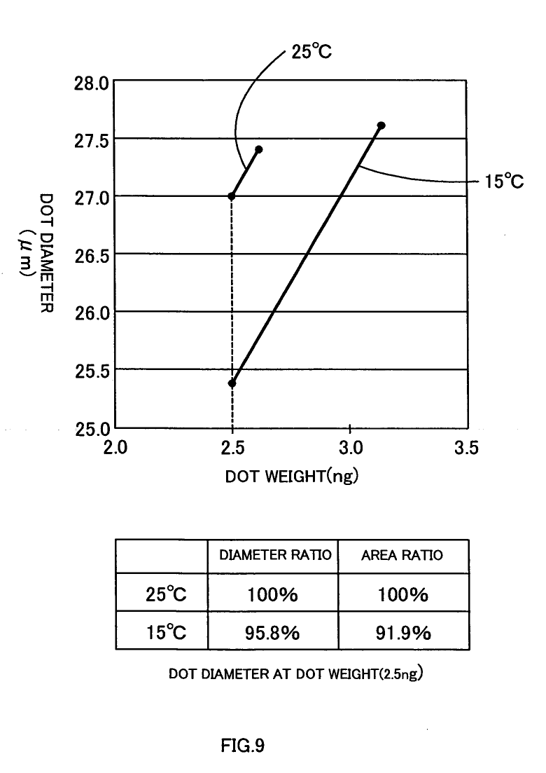

FIG. 9 is a graph of the relationship between the amount of ink ejected onto the printing medium and the diameter of the dot formed on the printing medium by the corresponding amount of ink, which was determined as a result of research by the Applicant. The figure shows a graph for a printing medium temperature of 15° C. and a printing medium temperature of 25° C. The horizontal axis indicates the dot weight (ng), and the vertical axis indicates the dot diameter (μm). when an ink drop weight 2.5 ng is ejected onto the printing medium, the dot diameter is about 25.5 μm when the medium temperature is 15° C. The dot diameter is about 27 μm when the medium temperature is 25° C. Considered in terms of diameter ratio and area ratio, where those values are assumed to be 100% at a medium temperature of 25° C., the diameter ratio at a medium temperature of 15° C. is 95.8%, and the area ratio is 91.9%.

That is, the dots are formed with a different diameter when the same ink weight is ejected at different medium temperatures. When the dot diameter changes in this manner, the coloring characteristics on the printing medium are different, resulting in different printing states. Changes in the printing state due to the medium temperature result in irregular printing quality. As described above, the color conversion module 98 references a color conversion table LUT in the conversion to data represented by the 256 gray scale level of CMYK used by the printer 22 for each pixel. The half tone module 99 executes a half tone process to disperse dots within half tone cells. differences in dot diameter can be absorbed by the modification of the extent to which the dots are dispersed by the half tone module 99.

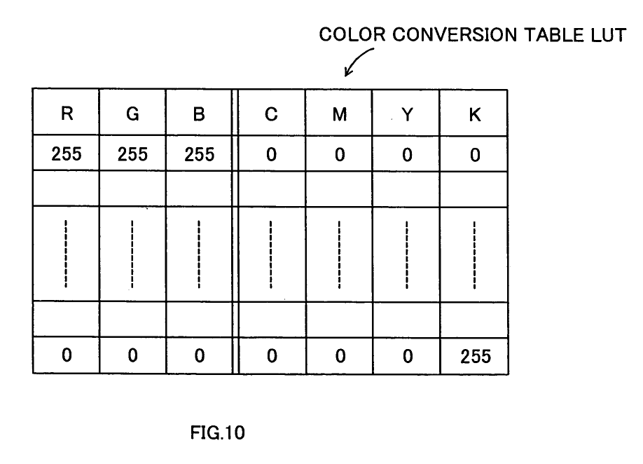

That is, when the medium temperature results in a smaller dot diameter, the dispersion of dots in the half tone cells can be increased to ensure the coloring characteristics per half tone cell unit, and when the medium temperature results in a larger dot diameter, the dispersion of dots in the half tone cells can be decreased to ensure the coloring characteristics per half tone cell unit. The dispersion of dots in the half tone cells can be modified according to the CMYK gray scale level that is determined during the color conversion from RGB data to CMYK data. The CMYK gray scale level is determined on the basis of the correspondence between the RGB gray scale level and the CMYK gray scale level stipulated in the color conversion table LUT, as illustrated in FIG. 10.

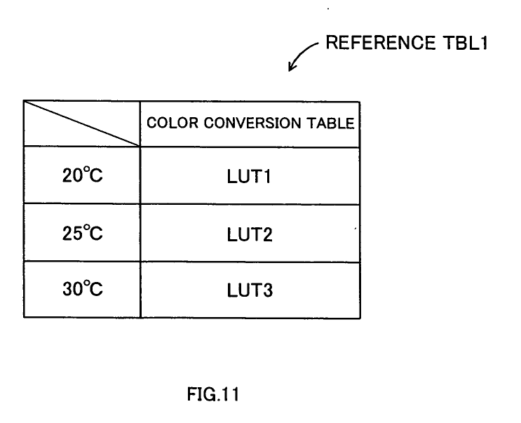

In this embodiment, a color conversion table LUT stipulating the CMYK gray scale level allowing the coloring characteristics to be generally uniform at each medium temperature is prepared in advance for temperature conditions corresponding to each medium temperature, and a reference table stipulating the correspondence between the temperature conditions and color conversion table is prepared. Color conversion tables for temperature conditions corresponding to the measured medium temperature can then be retrieved from the reference tables and switched to ensure that the coloring characteristics are generally uniform at different medium temperatures. FIG. 11 illustrates the structure of such a profile. In the reference table TBL 1 in the figure, color conversion tables LUT 1 through LUT 3 are matched for the various temperature conditions (20° C., 25° C., 30° C.).

Color conversion table LUT 1 corresponds to the color conversion table for 20° C., color conversion table LUT 2 corresponds to the standard color conversion table, and color conversion table LUT 3 corresponds to the color conversion table for 30° C. The reference table TBL 1 is stored in a memory medium such as ROM 82. To implement a color conversion process, the color conversion module 98 is engaged in two-way communication with the printer 22, retrieves the measured medium temperature, specifies one of the color conversion tables LUT 1 through LUT 3 corresponding to the retrieved medium temperature, and used the table for color conversion. The coloring characteristics on printing media can be made generally uniform at various medium temperatures through color conversion using specific color conversion tables LUT 1 through LUT 3 corresponding to the medium temperature.

When the color conversion tables LUT 1 through LUT 3 used in the color conversion are specified based on the reference table TBL 1, the temperature conditions (20° C., 25° C., 30° C.) closest to the measured medium temperature are detected to specific the color conversion table LUT 1 through LUT 3 corresponding to the temperature conditions. The method for specifying the color conversion table LUT 1 through LUT 3 is not limited. New color conversion tables may be prepared through interpolation or extrapolation based on the color conversion tables LUT 1 through LUT 3. Interpolation may be used when the measured medium temperature is between temperature conditions. Each element in the color conversion tables LUT 1 through LUT 3 corresponding to the two temperature conditions are referenced, the corresponding relationship to the measured medium temperature is extracted by interpolation, a new color conversion table is prepared based on the extracted correspondence, and it is used for the color conversion. Extrapolation may be used when the measured medium temperature is not between temperature conditions. Each element in the profiles for the two temperature conditions close to the medium temperature are referenced, the corresponding relationship to the measured medium temperature is extracted by extrapolation, a new color conversion table is prepared based on the extracted correspondence, and it is used for the color conversion.

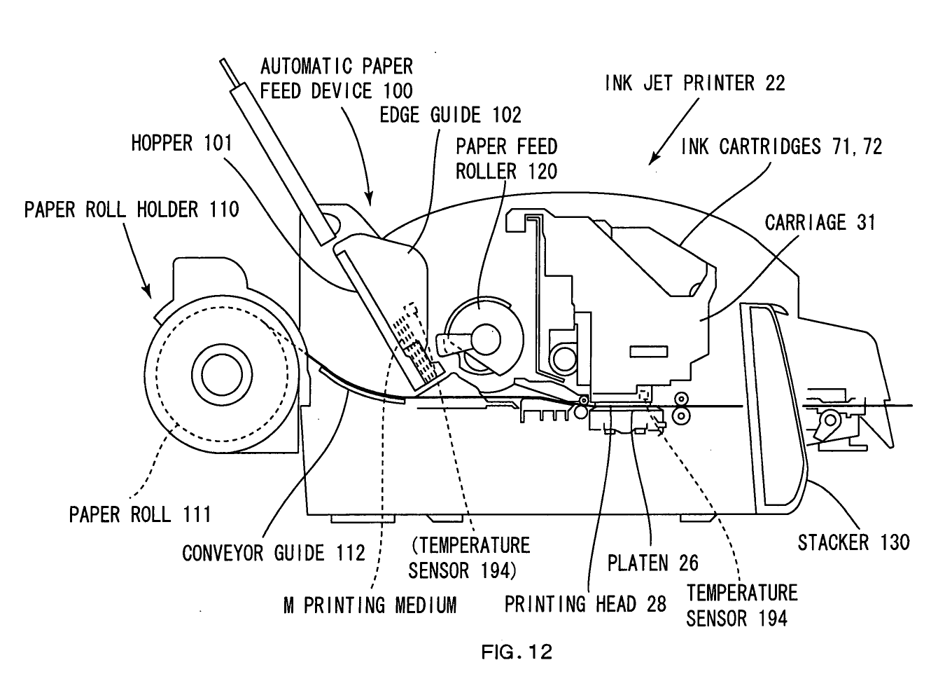

The position where the temperature sensor 194 for measuring the temperature of the medium M is located is not particularly limited, provided that the general surface of the printing medium can be measured. FIG. 12 illustrates the general structure of printer 22 hardware. In the figure, the printer 22 comprises an automatic feed apparatus 100 for feeding the printing medium M which has been stacked in a hopper 101, and a paper roll holder 110 on which a roll of paper 111 is mounted as the printing medium M. The printing medium M can be fed into the printer as the paper feed roller 120 rotates. The printing medium M fed into the printer is conveyed to the printing mechanism side which has the ink cartridges 71 and 72, carriage 31, platen 26, and printing head 28, where the medium can be printed by the printing mechanism.

The printed printing medium M is conveyed to an open stacker 130. In this structure, a temperature sensor 194 should be provided on the bottom surface of the carriage 31 on the other side from the printing medium M to allow the temperature of the printing medium M to be measured immediately prior to printing. On the other hand, a temperature sensor 194 can be located on side surface of an edge guide 102 formed in the hopper 101, and the temperature sensor 194 should be movably provided so as to come into general contact with the uppermost printing medium (printing medium first supplied into the printer in order to be printed) according to the number of printing media M that have been stacked, so that the temperature of the printing medium M can be measured by a simple structure. In this embodiment, the temperature of the printing medium M was measured as the temperature in the printer environment, but the environmental temperature is not limited to this. The temperature around the printer or in the temperature may be used.

6) Variants

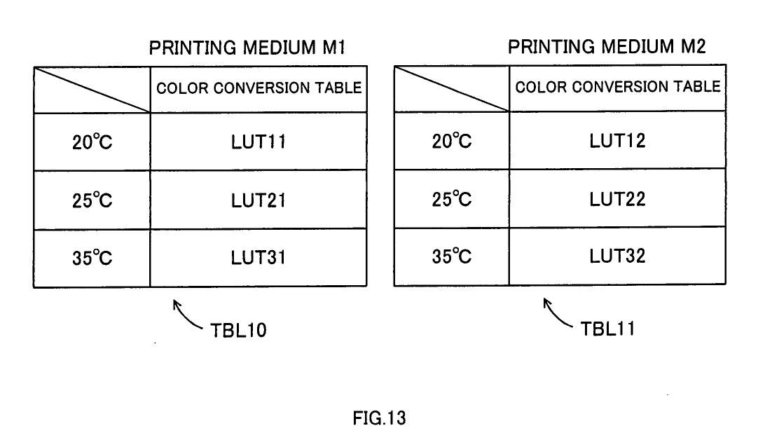

In the above embodiment, a structure utilizing the same reference table TBL 1 was used, irrespective of the grade of the printing medium M. As noted above, the diameter of the dots of ink ejected on the printing medium M depends on the temperature of the medium M. It is also known that the dot diameter is affected by the penetration of the ink into the printing medium M. Reference tables TBL 10 and 11 may also be prepared for grades of printing media (such as printing medium M1 and printing medium M2) as illustrated in FIG. 13, and they may be stored in ROM 45 or the like. In such cases, the color conversion module 98 can retrieve the grade of printing medium selected for printing, either the reference table TBL 10 or 11 can be specified based on the grade of the retrieved printing medium, and color conversion tables LUT 11 through LUT 31 or color conversion tables LUT 12 through 32 can be specified based on the measured medium temperature.

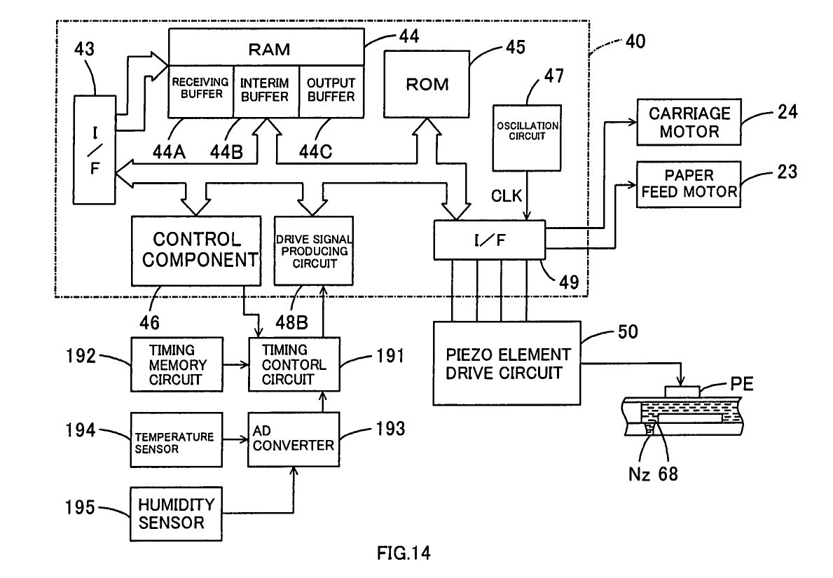

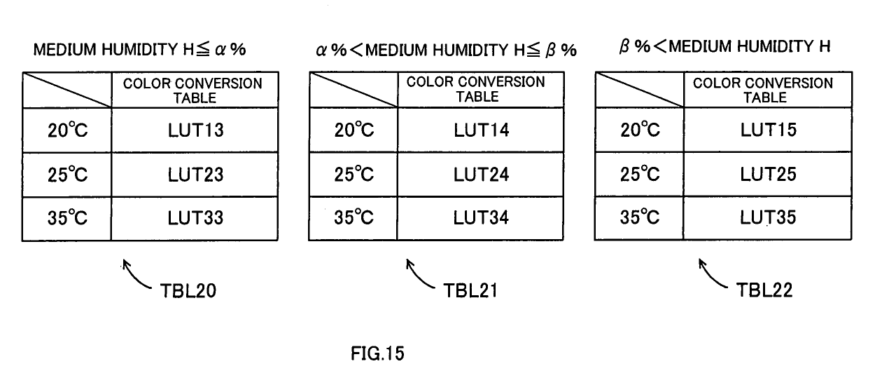

In the above embodiment, the color conversion table LUT used for color conversion was changed according to the measured medium temperature. It is known that the diameter of the dots formed by the ink ejected onto the printing medium M is also affected by the humidity of the printing medium M. As illustrated in FIG. 14, a humidity sensor 195 can be used, and the humidity of the printing medium M can be measured. The humidity sensor 195 can be located anywhere, provided that the humidity of the printing medium M can be measured. It may be located in the same manner as the temperature sensor 194 described above, for example. In such cases, as illustrated in FIG. 15, for example, a profile TBL 20 corresponding to cases where the medium humidity H is no more than α%, a profile TBL 21 corresponding to cases where the medium humidity H is more than α% but no more than β%, and a profile TBL 22 corresponding to cases where the medium humidity H is more than β% are stored in ROM 45 or the like. The color conversion module 98 specifies any of the profiles TBL 20 through 22 based on the measured medium humidity H, and specifies color conversion tables LUT 13 through 33, color conversion tables LUT 14 through 34, or color conversion tables LUT 15 through 35 based on the measured medium humidity.

7) Conclusion

Color conversion tables LUT stipulating CMYK gray scale levels permitting coloring characteristics to be generally uniform at varying medium temperatures are thus prepared for temperature conditions (20° C., 25° C., 30° C.) corresponding to the medium temperature, and a reference table TBL 1 stipulating the correspondence between the temperature conditions (20° C., 25° C., 30° C.) and the color conversion tables LUT 1 through LUT 3 is prepared. Color conversion tables LUT 1 through LUT 3 of temperature conditions (20° C., 25° C., 30° C.) corresponding to the measured medium temperature are thus retrieved from the reference table TBL 1, and are switched to allow coloring characteristics to be uniform at various medium temperatures.

1. A printing control method for printing upon color conversion of image data color space from a first color space to a second color space with reference to profiles stipulating the correspondence between the first and second color spaces, comprising the steps of:
inputting the image data;
measuring the environmental temperature in the printer environment; and
preparing at least two profiles to realize certain coloring characteristics on printing media under different temperature conditions, retrieving a profile according to the temperature conditions corresponding to the measured environmental temperature, and producing printing data as the image data undergoes color correction with reference to that profile.

2. A printing control method according to claim 1, wherein the profile stipulated for the temperature conditions closest to the measured environmental temperature is retrieved in the printing data producing step.

3. A printing control method according to claim 1, wherein, when the measured environmental temperature in the printing data producing step is between the aforementioned different temperature conditions, the profiles at the different temperature conditions are referenced, the correspondence between the first and second color spaces at the measured environmental temperature is extracted by interpolation, a profile is retrieved based on the extracted correspondence, and the retrieved profile is referenced.

4. A printing control method according to claim 1, wherein, when the measured environmental temperature in the printing data producing step is not between the aforementioned different temperature conditions, the profiles at the two temperature conditions close to the environmental temperature are referenced, the correspondence between the first and second color spaces at the measured environmental temperature is extracted by extrapolation, a profile is retrieved based on the extracted correspondence, and the retrieved profile is referenced.

5. A printing control method according to claim 1, further comprising the step of selecting the grade of the printing medium on which the printing data is printed by the printing apparatus, wherein the above profiles are produced in advance according to printing medium grade, a profile is retrieved in the printing data producing step on the basis of the temperature conditions corresponding to the measured environmental temperature and the grade of the printing medium selected in the above printing medium grade selection step, and the retrieved profile is referenced.

6. A printing control method according to claim 1, further comprising the step of preparing profiles according to different humidity conditions, and measuring the environmental humidity in the printer environment, wherein a profile is retrieved in the printing data producing step on the basis of the temperature conditions corresponding to the measured environmental temperature and the measured environmental humidity, and the retrieved profile is referenced.

7. A printing control apparatus capable of switching profiles that are referenced when printing upon color conversion of image data color space from a first color space to a second color space with reference to profiles stipulating the correspondence between the first and second color spaces, comprising:
an image data input component for inputting image data;
an environmental temperature sensor for measuring the environmental temperature in the printer environment;
a profile storage medium for storing at least two profiles stipulating the correspondence between the first and second color spaces capable of realizing certain coloring characteristics on printing media under different temperature conditions; and
a profile switching component for retrieving from the profile storage medium a profile according to the temperature conditions corresponding to the measured environmental temperature based on the profiles stored in the profile storage medium, and switching the profile during color conversion by the printing data producing component to the retrieved profile.

8. A printing control program product enabling a computer to execute a function capable of switching profiles stipulating the correspondence between a first color space and second color space when printing data is produced as certain first color space image data undergoes color conversion to a different second color space, comprising:
program code for an image data input step for inputting the image data;
program code for a printing data producing step for producing image data while image data undergoes color conversion with reference to the profile;
program code for an environmental temperature measuring step for measuring the environmental temperature in the printer environment; and
program code for profile switching step for retrieving from the profile storage medium a profile according to the temperature conditions corresponding to the measured environmental temperature based on the profiles stored in the profile storage medium, which stores at least two profiles stipulating said correspondence allowing certain coloring characteristics to be realized on printing media under different temperature conditions, and switching the profile during color conversion in the printing data producing step to the retrieved profile.
